(19) United States
(12) Patent Application Publication
(10) Pub. No.: US 2008/0154997 A1
(43) Pub. Date: Jun. 26, 2008

(54) SYSTEMS AND METHODS FOR FUNCTION CONTROL IN A CALCULATION DEVICE

(75) Inventor: Beatrice R. Aton, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/614,061

(22) Filed: Dec. 20, 2006

(51) Int. Cl. G06F 15/02

(52) U.S. Cl. 708/130

(57) ABSTRACT

Various systems and methods for controlling the functionality of calculation devices are disclosed. For example, some embodiments of the present invention provide function controlled calculation devices that include a functionality environment detector that is operable to receive an environment indication from a functionality environment. The calculation devices further include a processor and a computer readable medium. The computer readable medium includes instructions executable by the processor to perform a plurality of functions, where the plurality of functions are selected based at least in part on the environment indication.

### BACKGROUND OF THE INVENTION

The present invention is related to calculation devices, and more particularly, to systems and methods for controlling the functionality of a calculation device based on varying environments.

Use of calculators in a teaching or testing environment can be both an advantage and a disadvantage. The advantage lies in the fact that a student can easily perform computations that would otherwise take a considerable amount of time to perform by hand. This can save substantial classroom time. In contrast, the disadvantage is that through constant use of a calculator a student may never learn how a computation is being performed as they may rely exclusively on the calculator, or in a testing scenario a student with a more sophisticated calculator may be at some advantage. This can, of course, be detrimental to the student's academic pursuits or the virtue of the testing process.

The response to the aforementioned scenario is varied. For example, some teachers preclude the use of calculators in the classroom or testing situations altogether. Other teachers allow the use of calculators at all times and leave it to the student's discretion whether to rely exclusively on a calculator or not. Yet other teachers will allow the use of calculators during some aspects of classroom instruction but not others, and in varying degrees in exams. Yet other teachers allow use of only relatively unsophisticated calculators. Further, in some cases, a sophisticated calculator may be used during classroom instruction, but only a relatively unsophisticated calculator may be used in an exam. All of these different approaches result in confusion for both students and teachers, and often require a student to own and become versed in using both a sophisticated and unsophisticated calculator. This can be both costly and frustrating.

Thus, for at least the aforementioned reasons, there exists a need in the art for advanced systems and methods for controlling the functionality of calculation devices.

### BRIEF SUMMARY OF THE INVENTION

The present invention is related to calculation devices, and more particularly, to systems and methods for controlling the functionality of a calculation device based on varying environments.

Various systems and methods for controlling the functionality of calculation devices are discussed herein. For example, some embodiments of the present invention provide function controlled calculation devices that include a functionality environment detector that is operable to receive an environment indication from a functionality environment. Such an environment indication may, for example, identify which functions of the calculation device to enable and which to disable. The calculation devices further include a processor and a computer readable medium. The computer readable medium includes instructions executable by the processor to perform a plurality of functions that are selected based at least in part on the environment indication.

In some instances of the aforementioned embodiments, the calculation device further includes a wireless interface that is operable to transfer the environment indication from the functionality environment to the functionality environment detector. In various instances of the aforementioned embodiments, the calculation device further includes a keyboard with a number of keys. At least some of the keys when individually pressed cause execution of respective ones of the plurality of functions. Thus, for example, one of the keys may cause a memory store to occur, another key may cause a memory read to occur, while yet another key may cause a mathematical function to execute. In some cases, where a function is precluded, the key that otherwise would be used to cause execution of the particular function is disabled. In some particular instances of the aforementioned embodiments, the calculation device is a hand-held calculator with a display. The function that is precluded may be, but is not limited to, a memory store function, a memory read function, a mathematical function, or some combination of the aforementioned functions. In other instances, instead of precluding functionality, the environment indication causes an extension of the default functionality of the calculation device, This extension may be in addition to or in place of the previously discussed preclusion of functionality.

Other embodiments of the present invention provide methods for controlling the calculation device functionality differently depending upon the functionality environment in which it is operating. Such methods include defining a set of calculation device functionality available in a functionality environment, and transmitting the set of calculation device functionality. In some cases, transmitting the set of calculation device functionality is done via a wireless network. A calculation device brought within range of the functionality environment assumes the functionality prescribed by the environment. In some cases, the process of assuming the calculation device functionality includes precluding the use of one or more functions otherwise available via the calculation device when the device is operated in a default mode.

In some particular instances of the aforementioned embodiments, the functionality environment is a testing environment. In such an environment, one of the precluded functions may be a memory store or a memory read function. In other cases, one of the precluded functions may be a mathematical function.

Yet other embodiments of the present invention provide methods for customizing calculation device functionality. Such methods include providing a calculation device that includes a functionality environment detector; a processor; and a computer readable medium. The computer readable medium includes instructions executable by the processor to: perform a plurality of functions; to preclude performance of one or more of the plurality of functions based at least in part on an environment indication. The methods further include introducing the calculation device into a functionality environment, and receiving the environment indication from the functionality environment. Based at least in part on the environment indication, one or more of the plurality of functions is precluded.

This summary provides only a general outline of some embodiments according to the present invention. Many other objects, features, advantages and other embodiments of the present invention will become more fully apparent from the following detailed description, the appended claims and the accompanying drawings.

### BRIEF DESCRIPTION OF THE DRAWINGS

A further understanding of the various embodiments of the present invention may be realized by reference to the figures which are described in remaining portions of the specification. In the figures, like reference numerals are used throughout several drawings to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 depicts a calculation device in relation to three different functionality environments in accordance with one or more embodiments of the present invention;

FIG. 2 is a block diagram of a function controlled calculation device in accordance with various embodiments of the present invention;

FIG. 3 is a flow diagram showing function preclusion in accordance with some embodiments of the present invention;

FIG. 4 is a flow diagram showing both function preclusion and function augmentation in accordance with various embodiments of the present invention; and

FIG. 5 is a flow diagram showing the method of FIG. 4 augmented to include a timeout function in accordance with particular embodiments of the present invention.

### DETAILED DESCRIPTION OF THE INVENTION

The present invention is related to calculation devices, and more particularly, to systems and methods for controlling the functionality of a calculation device based on varying environments.

Some embodiments of the present invention provide functionality controlled calculation devices. As used herein, the phrase “calculation device” is used in its broadest sense to mean any electronic device that is capable of performing a plurality of functions. Thus, a calculation device may be, but is not limited to a hand-held calculator. Such a hand-held calculator may include a keyboard and a display. The keyboard includes various keys with some of the keys being tied to the execution of particular mathematical and/or storage functions. Such functionality controlled calculation devices are capable of modifying available functionality whenever introduced into a functionality environment. Based on the disclosure provided herein, one of ordinary skill in the art will recognize a variety of calculation devices that may be used in relation to one or more embodiments of the present invention.

As used herein, the phrase “functionality environment” is used in its broadest sense to mean any region defined either physically or virtually that allows for the use of a particular set of functionality. Thus, for example, a functionality environment may be a testing center in which a wireless communication signal is transmitted. The wireless communication signal may indicate, for example, that a memory store function of a calculation device cannot be used or that a memory read function of a calculation device cannot be used. As another example, a functionality environment may be a classroom in which a wireless communication signal is transmitted. The wireless communication signal may indicate one or more functions of the calculation device that may not be used within the functionality environment.

The aforementioned calculation devices include a functionality environment detector that is operable to receive an environment indication from a functionality environment. The environment indication may be any indicator of the functionality this is enabled or otherwise allowed in the functionality environment. The calculation device further includes a processor and software or firmware that is executable by the processor to perform the functions supported by the calculation device, and to preclude use of one or more of those functions whenever the calculation device is introduced into a functionality environment. In general, the functions that are generally enabled in the calculation device are referred to a default functions. The functionality that is precluded is defined by the particular functionality environment and is manifest as an environment indication. In some cases, the environment indication is transmitted via a wireless network, however, in one or more cases the network may be a wired network. Various wireless or wired networks that are known in the art may be used in accordance with the various embodiments of the present invention.

It should be noted that desired functionality may be retained by a user upon entering a classroom or testing functionality environment by simply disabling the ability for the calculation device to detect the presence of a functionality environment. Thus, where functionality limits are to be imposed by a teacher or proctor, it may be that the student or participant must show the calculation device to the authority in charge who then verifies that the calculation device has not been disabled and that the defined functionality limitation has been properly implemented by the calculation device. Alternatively, the calculation devices may be designed such that all functionality is lost if for some reason the ability to receive information from a functionality environment is disabled or otherwise impeded.

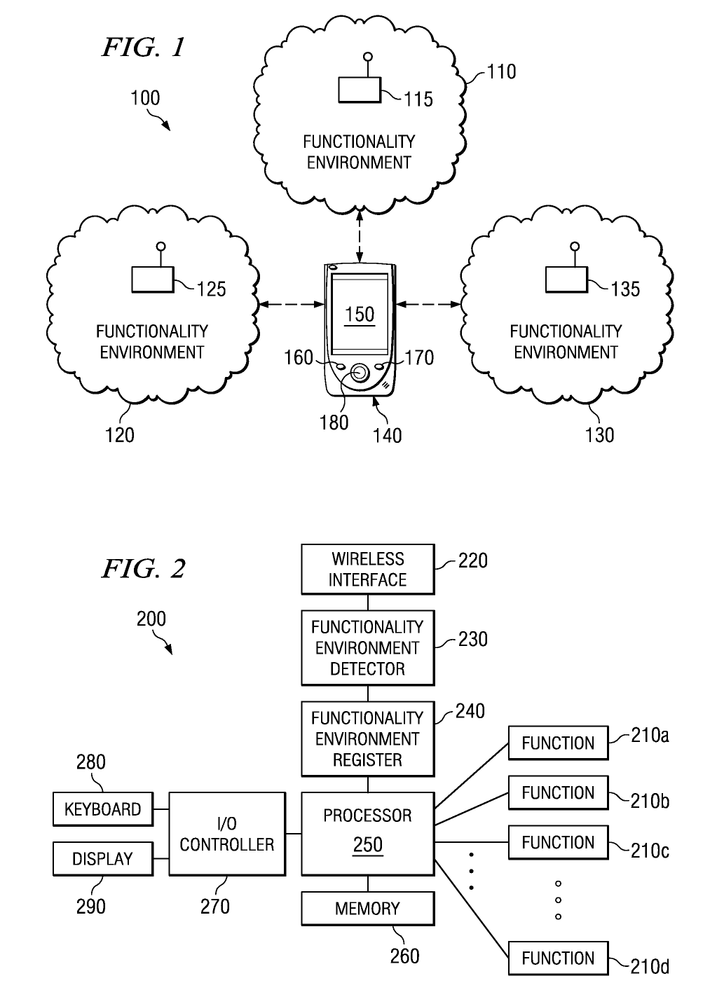

Turning to FIG. 1, a calculation device 140 is shown in relation to three different functionality environments 110, 120, 130. Calculation device 140 includes a display 150 and a number of keys 160, 170, 180 that together form a keyboard. In some cases, one or more of key 160, key 170 or key 180 when pressed causes a particular function to be performed by calculation device 140. Such functions may be, but are not limited to, memory store operations, memory read operations, or mathematical functions. Mathematical functions may include, but are not limited to, logarithmic functions, graphing functions, integrating functions, and matrix functions. Based on the disclosure provided herein, one of ordinary skill in the art will recognize a number of other mathematical functions to which embodiments of the present invention may be applied.

For purposes of illustration, functionality environment 110 is a testing environment in which all functions of calculation device 140 can be used except for the memory store function(s). In some cases, such as, for example, standardized testing situations, there is a desire to maintain the secrecy of the questions asked. In such cases, it is desirable for participants in an exam to be precluded from storing the test questions to the memory of calculation device 140. Further, in such exams, it is likely that the memory storage capability of calculation device 140 is not needed for any legitimate aspects of the examination process. Hence, a wireless transmitter 115 may be installed in functionality environment 110 that transmits an environment indication that is received by calculation device 140 when it is moved within range of the transmitter. In this case, functionality environment 110 physically covers an area approximately equal to the transmission area of wireless transmitter 115. This could be, for example, a building or a classroom area. When calculation device 140 receives the environment indication it decodes the environment indication to find out that the memory store functionality of calculation device 140 must be disabled. In response, calculation device 140 precludes all memory store functions until calculation device 140 is removed from functionality environment 10. Wireless transmitter 115 may be included with an environment controller. Such an environment controller may be programmed by a proctor, teacher or other person in authority to select the functionality to be allowed on calculation devices brought into functionality environment 110.

Functionality environment 120 is a testing environment in which all functions of calculation device 140 can be used except for the memory read function and one particular mathematical function. In some cases, such as, for example, testing in a high school, a teacher may want to determine a student's knowledge of a topic, rather than simply the student's ability to use and/or program their calculation device. Hence, during the examination, a wireless transmitter 125 may be installed in functionality environment 120 that transmits an environment indication that is received by calculation device 140 when it is moved within range of the transmitter. In this case, functionality environment 120 physically covers an area approximately equal to the transmission area of wireless transmitter 125. This could be, for example, a building or a classroom area. When calculation device 140 receives the environment indication it decodes the environment indication to find out that the memory read functionality, and the particular mathematical function of calculation device 140 must be disabled. In response, calculation device 140 precludes all memory reads and access to the particular mathematical function until calculation device 140 is removed from functionality environment 120. Wireless transmitter 125 may be included with an environment controller. Such an environment controller may be programmed by a proctor, teacher or other person in authority to select the functionality to be allowed on calculation devices brought into functionality environment 120.

Functionality environment 130 is a classroom environment in which all functions of calculation device 140 can be used except for a few of the more sophisticated mathematical functions that are supported by calculation device 140. In this case, the teacher in the classroom may want to force the students to perform mathematical calculations by hand for at least a portion of the class. In this way, the students are encouraged to learn the topics at hand and do not become overly reliant on their calculation devices. To do this, a wireless transmitter 135 may be installed in functionality environment 130 that transmits an environment indication that is received by calculation device 140 when it is moved within range of the transmitter. In this case, functionality environment 130 physically covers an area approximately equal to the transmission area of the transmitter. This could be, for example, a building or a classroom area. When calculation device 140 receives the environment indication it decodes the environment indication to find out that the designated mathematical functions of calculation device 140 must be disabled. In response, calculation device 140 precludes use of any of the designated mathematical functions until calculation device 140 is removed from functionality environment 130. Wireless transmitter 135 may be included with an environment controller. Such an environment controller may be programmed by a proctor, teacher or other person in authority to select the functionality to be allowed on calculation devices brought into functionality environment 130.

It should be reiterated that the aforementioned functionality environments are merely exemplary. Based on the disclosure provided herein, one of ordinary skill in the art will recognize that other types of functionality environments may be developed and utilized in accordance with one or more embodiments of the present invention. Also, it should be noted that functionality environments 110, 120, 130 may be created in substantially any location, whether the location is defined physically or virtually. As an example of a virtual functionality environment, calculation device 140 may be attached to a Universal Serial Bus port of a personal computer during an online teaching scenario accessed via the Internet. As such, environment indications may be provided to calculation device 140 via the Internet. Further, it should be noted that any of a number of functionality combinations may be precluded for any given functionality environment. As an example, where the functionality environment is a classroom, it may be that three mathematical functions are disabled by a functionality environment on the first week of class, and only two are disabled on the second week of class. As such, it should be noted that functionality environments may evolve to meet the changing needs of a testing, teaching, or other situation.

It should be noted that calculation devices 140 may also be communicably coupled to a respective functionality environment via a wired connection instead of the previously discussed wireless connection. In one particular embodiment of the present invention, four calculation devices are wire connected to a functionality environment via a hub, while other calculation devices in the functionality environment are wirelessly connected. In other cases, a group of four calculation devices may be wired to the aforementioned hub, and wireless transmitter may be wirelessly communicating to the hub. Based on the disclosure provided herein, one of ordinary skill in the art will recognize a variety of wired and/or wireless connectivity that may be used to connect calculation devices to a respective functionality environment.

Further, in some embodiments of the present invention calculation devices must be registered with a particular functionality environment before they will be enabled or disabled by the functionality environment. Thus, for example, a professor may require all students to register any calculation device brought within a classroom. Thus, when a registered device is detected it can be disabled without having an undesired impact on a calculation device that is, for example, in a classroom next door. Registration assures that where functionality environments wirelessly overlap, calculation devices are operated on by the appropriate functionality environment.

Turning to FIG. 2, a block diagram of a function controlled calculation device 200 in accordance with various embodiments of the present invention is shown. Function controlled calculation device 200 includes a wireless interface 220. Wireless interface 220 allows calculation device 200 to detect the presence of a functionality environment. Wireless interface 220 may be any wireless interface known in the art, and is selected to match the wireless transmission format supported by a functionality environment. As just some of many examples, wireless interface 220 may be an 802.11g compliant interface or a Bluetooth compliant interface. Based on the disclosure provided herein, one of ordinary skill in the art will recognize a variety of wireless interfaces that may be utilized in accordance with one or more embodiments of the present invention. Further, in some cases, wireless interface 220 Thus, for example, wireless interface 220 may be replaced with a wired interface in the situation where the functionality environment is to be detected via a wired interface.

Wireless interface 220 decodes a wireless transmission available to calculation device 200. The decoded wireless transmission is provided to a functionality environment detector 230. Functionality detector 230 accepts the transmitted information from wireless interface 220 and determines what functions are allowed or required in the detected functionality environment. This information is stored in a functionality environment register 240 that is used to govern which of the functions available to calculation device 200 will remain available to a user when the user is in the detected functionality environment.

Calculation device 200 includes a processor 250 at its core that is capable of accessing and executing software and/or firmware instructions that are maintained in a memory 260. Processor 250 may be any processor known in the art and may include, but is not limited to, the various different types of microprocessors that are available. It should be noted that memory 260 may be any computer readable medium known in the art. As used herein, the phrase “computer readable medium” is used in its broadest sense to mean any medium that can be read and/or written using electrical signals. Thus, for example, a computer readable medium may be, but is not limited to, a random access memory, a flash memory, an insertable memory card, a hard disk drive, a CD-ROM, and EEPROM, combinations of the aforementioned, and/or the like.

Processor 250 can execute the instructions maintained in memory 260 to perform a number of different functions 210. For example, when two operands are entered using a keyboard 280, the entry of the operands may be provided to processor 250 via an I/O controller 270. In turn, another key on keyboard 280 may be pressed that causes a mathematical function to be applied to the two operands. Such mathematical functions are well known in the art and too numerous to be discussed individually in this document. Alternatively, or in addition, a key on keyboard 280 may be pressed that causes a function to execute that stores selected information to memory 260. Again, alternatively or in addition, a key on keyboard 280 may be pressed that causes a function to execute that retrieves selected information from memory 260 and provides it to the user via a display 290. In one particular embodiment of the present invention, functionality environment register 240 includes enable bits that are each associated with respective ones of functions 210. Where the enable bit is set, the respective one of functions 210 is enabled. Alternatively, where an enable bit is not set, the respective function associated with the particular enable bit is not accessible to the user of calculation device 200.

In operation where no functionality environment is detected, a default set of enable bits are set such that the default functionality of calculation device 200 is accessible to the user thereof. In some cases where no functionality environment is detected, all of the enable bits are set allowing access to the full functionality of calculation device 200. In other cases where no functionality environment is detected, less than all of the enable bits are set such that less than the full functionality is available to the user. In such cases, some functions of calculation device 200 may only be available upon moving calculation device 200 into a functionality environment that calls for some of the otherwise disabled functions.

When calculation device 200 is brought into range of a functionality environment, the requirements of the functionality environment are received and decoded by wireless interface 220 and functionality environment detector 230. This results in modifying the state of one or more of the enable bits of functionality environment register 240 from the default state. Where an enable bit was previously set, but is unset because calculation device 200 is moved within range of the functionality environment, then a previously available function 210 becomes inaccessible to the user. Alternatively, where an enable bit was previously not set, but is set because calculation device 200 is moved within range of the functionality environment, then a previously inaccessible function 210 becomes available to the user.

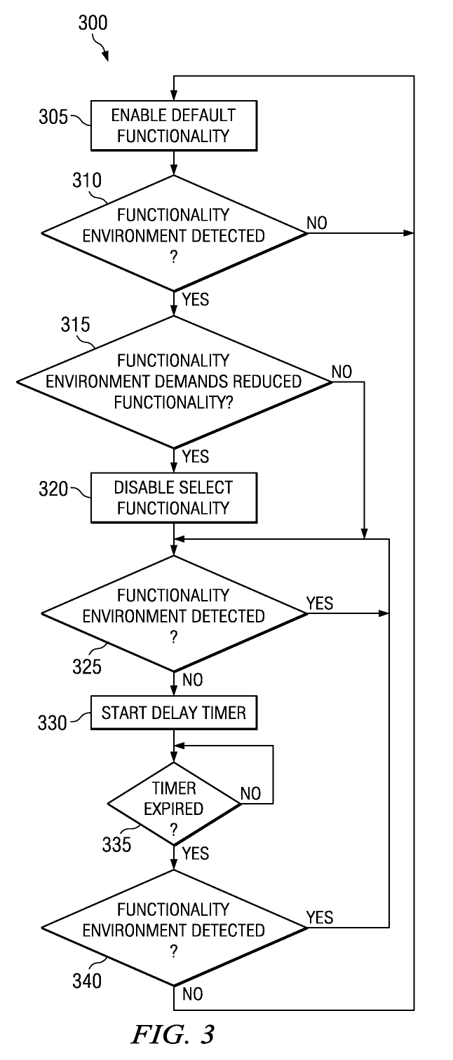

Turning to FIG. 3, a flow diagram 300 depicts a method in accordance with one or more embodiments of the present invention for precluding the use of a calculation device function based upon moving the calculation device within range of a functionality environment. Following flow diagram 300, the default functionality of the calculation device is enabled (block 305). As discussed above, this may include setting a number of enable bits that each correspond to a function that is supported when the calculation device is operating outside of a functionality environment. In some cases, this may include enabling all of the functionality of the calculation device. It is then determined whether a functionality environment is detected (block 310). Detecting a functionality environment involves receiving a signal transmitted by a functionality environment. In some cases, the signal identifying the functionality environment is wirelessly transmitted, while in other cases the transmission is done over some wired medium. Where a signal from a functionality environment is not detected (block 310), it is assumed that the calculation device is operating in an undefined zone (i.e., outside of a functionality environment). In such a case, the default functionality is maintained (block 305). It should be noted, as discussed above, precautions may be desired to avoid tampering with the ability of the calculation device to receive information from a functionality environment to avoid the scenario where the calculation device operates in default mode even though it is in a functionality environment.

Where it is determined that the calculation device is being operated within a functionality environment (block 310), it is next determined if the functionality environment requires disabling one or more functions of the calculation device (block 315). Where functions are to be disabled (block 315), they are (block 320). As set forth above, disabling functions may be done using any approach in the art including, for example, unsetting enable bits maintained in a functionality environment register.

The location of the calculation device is then monitored to determine whether it is removed from the functionality environment or whether the functionality environment is turned off (block 325). Where the functionality environment continues to be detected (block 325), the calculation device continues to make the functions called for by the functionality environment available to the user. However, if the calculation device fails to detect the previously detected functionality environment (block 325), a timer is started (block 330). At the end of the period counted by the timer (block 335), another attempt to detect the functionality environment is performed (block 340). Where the functionality environment is again detected (block 340), it is assumed that some intermittent error or some unexpected movement of the calculation device occurred, but that the calculation device is still operating within the functionality environment. In such a case, the calculation device continues to offer the functionality called for by the functionality environment. Otherwise, where the functionality environment is no longer detected (block 340), it is assumed that the calculation device is now operating outside of the functionality environment. In such a case, operation of the calculation device is returned to the default mode of operation (block 305).

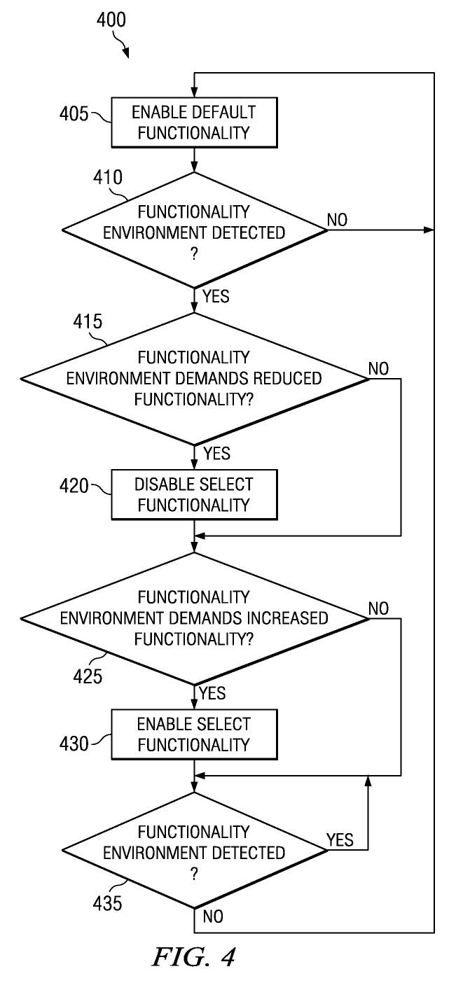

Turning to FIG. 4, a flow diagram 400 depicts another method in accordance with various embodiments of the present invention for both precluding and enabling the use of calculation device functions based upon moving the calculation device within range of a functionality environment. Following flow diagram 400, the default functionality of the calculation device is enabled (block 405), and continues enabled until a functionality environment is detected (block 410). Where it is determined that the calculation device is being operated within a functionality environment (block 410), it is next determined if the functionality environment requires disabling one or more functions of the calculation device (block 415). Where functions are to be disabled (block 415), they are (block 420).

It is also determined whether one or more functions are to be enabled to provide increased functionality when compared with the default operational mode of the calculation device (block 425). Where additional functionality is to be enabled (block 425), the identified functionality is enabled. Again, this may be done by setting an enable bit in a functionality environment register that corresponds to the desired functionality as discussed above, or by some other mechanism. It is then determined whether the calculation device is still operating in the functionality environment (block 435). Where it continues to operate in the functionality environment, the calculation device continues to offer the functionality called for by the functionality environment. Otherwise, where the functionality environment is no longer detected (block 435), it is assumed that the calculation device is now operating outside of the functionality environment. In such a case, operation of the calculation device is returned to the default mode of operation (block 405).

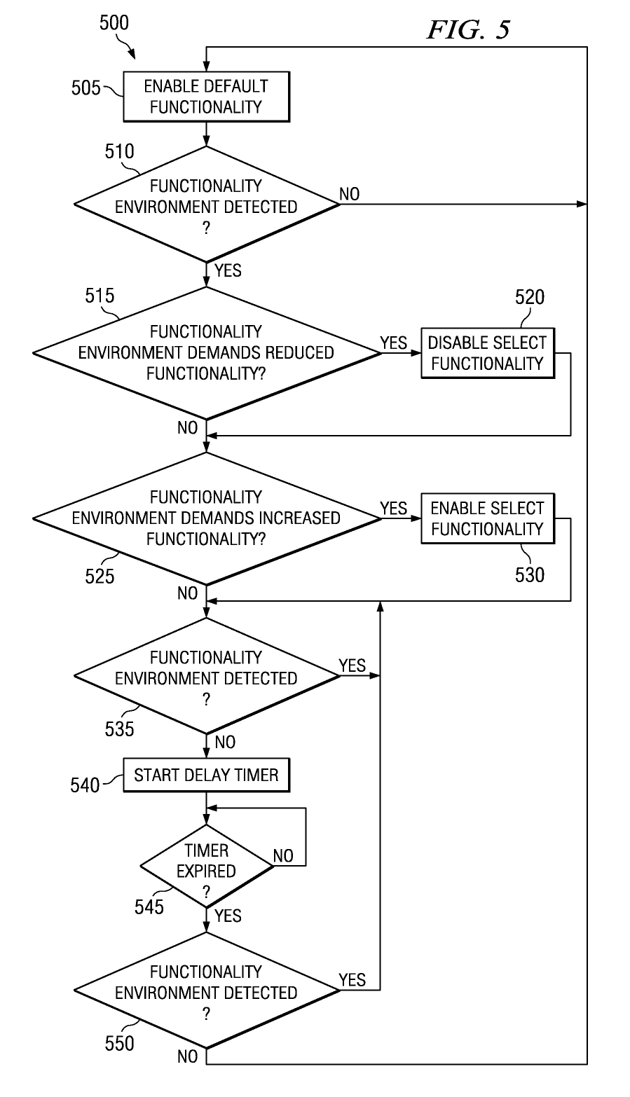

Turning to FIG. 5, a flow diagram 500 shows the method of FIG. 4 augmented to include a timeout function in accordance with particular embodiments of the present invention. Following flow diagram 500, the default functionality of the calculation device is enabled (block 505), and continues enabled until a functionality environment is detected (block 510). Where it is determined that the calculation device is being operated within a functionality environment (block 510), it is next determined if the functionality environment requires disabling one or more functions of the calculation device (block 515). Where functions are to be disabled (block 515), they are (block 520).

It is also determined whether one or more functions are to be enabled to provide increased functionality when compared with the default operational mode of the calculation device (block 525). Where additional functionality is to be enabled (block 525), the identified functionality is enabled. It is then determined whether the calculation device is still operating in the functionality environment (block 535). Where it continues to operate in the functionality environment, the calculation device continues to offer the functionality called for by the functionality environment. If the calculation device fails to detect the previously detected functionality environment (block 535), a timer is started (block 540). At the end of the period counted by the timer (block 545), another attempt to detect the functionality environment is performed (block 550). Where the functionality environment is again detected (block 550), it is assumed that some intermittent error or some unexpected movement of the calculation device occurred, but that the calculation device is still operating within the functionality environment. In such a case, the calculation device continues to offer the functionality called for by the functionality environment. Otherwise, where the functionality environment is no longer detected (block 550), it is assumed that the calculation device is now operating outside of the functionality environment. In such a case, operation of the calculation device is returned to the default mode of operation (block 505).

As just some advantages of one or more embodiments of the present invention, a student or exam participant may be enabled to purchase only one calculation device and to use that calculation device in a number of situations without consideration of whether the default operation of the calculation device provides functionality that otherwise would not be allowed in the situation. This allows a student to become versed in the use of one calculator, and not worry about the possibility of having to purchase and learn another calculator for the purpose of taking an exam. As another advantage, using one or more embodiments of the present invention, a teacher is not required to monitor the use of calculators in the classroom, but rather has the ability to simply disable detrimental functionality on the calculators. A teacher may wish to limit functionality available on the student's calculators to a narrow set of functionality carefully tailored to accentuate the classroom experience, while limiting a student's ability to misuse their calculator during class. As a particular example, a teach may be able to use one or more embodiments of the present invention to prevent students from playing games during the instruction period. Based on the disclosure provided herein, one of ordinary skill in the art will recognize other advantages that are achievable using embodiments of the present invention.

In conclusion, the present invention provides novel systems, devices, methods and arrangements for enabling and/or disabling the functionality of a calculation device. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A function controlled calculation device, the calculation device comprising:
a functionality environment detector, wherein the functionality environment detector is operable to receive an environment indication from a functionality environment;
a processor; and
a computer readable medium, wherein the computer readable medium includes instructions executable by the processor to:
perform a plurality of functions; and
to modify access to one or one or more of the plurality of functions based at least in part on the environment indication.

2. The calculation device of claim 1, wherein the calculation device further comprises: a wireless interface, and wherein the wireless interface is operable to transfer the environment indication from the functionality environment to the functionality environment detector.

3. The calculation device of claim 1, the calculation device further comprises:
a keyboard, wherein respective keys of the keyboard when individually pressed cause execution of respective ones of the plurality of functions.

4. The calculation device of claim 3, wherein modifying access to one or one or more of the plurality of functions includes precluding performance of at least one of the plurality of functions, and wherein upon preclusion of the one or more of the plurality of functions that is precluded based at least in part on the environment indication, a key of the keyboard that is programmed to cause execution of the precluded function is disabled.

5. The calculation device of claim 1, wherein the calculation device further includes a display.

6. The calculation device of claim 1, wherein the calculation device is a hand-held calculator.

7. The calculation device of claim 1, wherein modifying access to one or one or more of the plurality of functions includes precluding performance of at least one of the plurality of functions, and wherein the precluded function is a memory is a memory store function.

8. The calculation device of claim 1, wherein modifying access to one or one or more of the plurality of functions includes precluding performance of at least one of the plurality of functions, and wherein the precluded function is mathematical function.

9. A method for controlling the calculation device functionality in a defined environment, the method comprising:
defining a set of calculation device functionality available in a functionality environment;
transmitting the set of calculation device functionality, wherein a calculation device brought within the functionality environment assumes the calculation device functionality.

10. The method of claim 9, wherein the process of assuming the calculation device functionality includes precluding the use of one or more functions otherwise available via the calculation device.

11. The method of claim 9, wherein the functionality environment is a testing environment, and wherein one of the one or more functions of the calculation device that is precluded is a memory store function.

12. The method of claim 9, wherein the functionality environment is a testing environment, and wherein one of the one or more functions of the calculation device that is precluded is a mathematical function.

13. The method of claim 9, wherein assuming the calculation device functionality includes extending the functionality to include at least one customized function not otherwise available via the calculation device.

14. The method of claim 9, wherein transmitting the calculation device functionality is done via a wireless network.

15. The method of claim 9, wherein the calculation device is a hand-held calculator.

16. A method for customizing calculation device functionality, the method comprising:
providing a calculation device, wherein the calculation device includes:
a functionality environment detector;
a processor; and
a computer readable medium, wherein the computer readable medium includes instructions executable by the processor to:
perform a plurality of functions;
to preclude performance of one or more of the plurality of functions based at least in part on an environment indication; and
introducing the calculation device into a functionality environment; and
receiving the environment indication from the functionality environment; and
based at least in part on the environment indication, precluding use of the one or more of the plurality of functions.

17. The method of claim 16, wherein the calculation device further comprises a wireless interface, and wherein the method receiving the environment indication is done via the wireless interface.

18. The method of claim 16, wherein the calculation device is a calculator with a keyboard, and wherein a key on the keyboard is specifically designated to cause the precluded function to execute.

19. The method of claim 18, wherein upon preclusion of the precluded function, the key on the keyboard that is specifically designated to cause the precluded function to execute is disabled.

20. The method of claim 16, wherein the precluded function is selected from a group consisting of: a memory store function; a memory read function, and a mathematical function.
